(19) United States
(12) Patent Application Publication
(10) Pub. No.: US 2016/0144855 A1
(43) Pub. Date: May 26, 2016

(54) VIBRATION DAMPING CONTROL SYSTEM FOR VEHICLE

(71) Applicant: TOYOTA JIDOSHA KABUSHIKI KAISHA, Aichi (JP)

(72) Inventor: Takashi SAITO, Fuji-shi (JP)

(73) Assignee: TOYOTA JIDOSHA KABUSHIKI KAISHA, Toyota-shi, Aichi (JP)

(21) Appl. No.: 14/906,039

(22) PCT Filed: Aug. 5, 2013
(86) PCT No.: PCT/JP2013/071151

§ 371 Date: Jan. 19, 2016

(51) Int. Cl. B60W 30/02; B60W 20/00; B60T 8/1755; B60W 10/04; B60W 10/184

(52) U.S. Cl. CPC B60W 30/02; B60W 10/04; B60W 10/184; B60T 8/1755; B60W 20/00

(57) ABSTRACT

A vibration damping control system for vehicles is provided to prevent an interference between a driving force control of four-wheel drive mode and a driving force control to suppress sprung vibrations. The vibration damping control system is configured to suppress sprung vibrations of the vehicle in which a driving force and a braking force applied to front wheels and a driving force and a braking force applied to rear wheels can be controlled separately based on a plurality of data including a required driving force representing a running condition, by controlling at least any one of the driving forces or the braking forces applied to the front wheels and the rear wheels. The vibration damping control system restricts the control of the driving forces or the braking forces applied to the front wheels and the rear wheels to suppress the sprung vibrations during propelling the vehicle under four-wheel drive mode in which the driving forces delivered to the front wheels and to the rear wheels are controlled based on the plurality of data including the required driving force representing the running condition.

### TECHNICAL FIELD

The present invention relates to a system for damping vibrations of a vehicle, and especially to a system for suppressing vibrations of a vehicle caused by vertical motions of front side and rear side of the vehicle such as a pitching.

### BACKGROUND ART

Bouncing (i.e., pitching) of the vehicle in fore and aft positions results from a change in a drive torque of driving wheels derived from a change in an output power of a prime mover. Specifically, the bouncing of the vehicle is caused by a vertical motion of the wheels through a suspension. That is, such bouncing may be suppressed by controlling the drive torque of the driving wheels. In the conventional art, various kinds of control systems of this kinds have been proposed.

For example, Japanese Patent Laid-Open No. 2009-273275 describes a vibration damping system for an in-wheel motor vehicle in which all four wheels are individually provided with a motor. The system taught by Japanese Patent Laid-Open No. 2009-273275 is configured to estimate bouncing or pitching of the vehicle based on a stroke of a suspension detected by a sensor or a detection value of a vertical acceleration sensor, and to calculate a driving forces of front wheels and rear wheels or a ratio between those driving forces (i.e., a drive force ratio) required to suppress the bouncing or pitching. Then, front wheel motors and rear wheel motors are controlled in such a manner to achieve the drive forces or the drive force ratio thus calculated. According to the teachings of Japanese Patent Laid-Open No. 2009-273275, in order to reduce hunting or chattering noise, the system is further configured to control the driving force of the motor by applying a braking force to the wheel while the driving force is changed to suppress vibrations across zero, that is, while applying the driving force and the braking force alternately to the wheels.

As described in the above-mentioned publication, in the vehicle in which the driving force of the front wheels and the driving force of the rear wheels can be controlled separately, sprung vibration resulting from a change in the drive torque generated by the prime mover can be suppressed by changing driving forces of the front wheels and the rear wheels. In the four-wheel drive mode, although a running stability, a turning stability, a running performance on a rough road etc. may be improved, a power loss would be increased. For this reason, the vehicle is basically propelled in the two-wheel drive mode for providing power only to the front wheels or to the rear wheels during coasting on a flat road where a gradient is small.

Under the two-wheel drive mode, the driving force may be distributed to the front wheels and the rear wheels to suppress the sprung vibration. In this case, the sprung vibration may be suppressed with no effect to the running performance by adjusting a distribution ratio of the total required driving force to the front wheels and to the rear wheels. However, in order to achieve the required driving force or to maintain the running stability when an accelerator pedal is depressed deeply (i.e., at full throttle) or when a tire slippage occurs, the power distribution ratio to the front wheels and to the rear wheels is controlled in such a manner to propel the vehicle under the four-wheel drive mode. In this case, if the driving forces of the front wheels and the rear wheels are controlled to suppress the sprung vibration, the sprung vibration suppressing control and the torque control for ensuring the acceleration and the running stability have to be executed simultaneously. However, parameters used in those controls to determine control torques are different and hence it is rather difficult to determine the control torque possible to achieve both objectives of the different controls. For this reason, the acceleration, the running stability, the vibration suppressing performance may be deteriorated.

### DISCLOSURE OF THE INVENTION

The present invention has been conceived noting the foregoing technical problems, and it is therefore an object of the present invention is to provide a vibration damping control system that can prevent deterioration in driving performance of a vehicle.

In order to achieve the above-explained objective, the vibration damping control system according to the present invention is configured to restrict a control of the driving forces or the braking forces applied to the front wheels and the rear wheels to suppress sprung vibrations during propelling the vehicle under four-wheel drive mode in which the driving forces is delivered to the front wheels and to the rear wheels.

To this end, a control amount to suppress the sprung vibrations under the four-wheel drive mode is reduced to be smaller than that under the two-wheel drive mode. Alternatively, the sprung vibration suppressing control by adjusting the driving forces or the braking forces applied to the front wheels and to the rear wheels may also be inhibited under the four-wheel drive mode.

Specifically, the vibration damping control system according to the present invention is further configured: to calculate the driving force to suppress the sprung vibrations using a vehicle model as an equation of motion of the vehicle; to calculate a total driving force by adding said driving force to a driving force calculated based on the required driving force; and to calculate the driving forces distributed to the front wheels and to the rear wheels. In addition, a gain used to calculate the driving force to suppress the sprung vibrations under the four-wheel drive mode may be reduced to be smaller than that used to calculate the driving force to suppress the sprung vibrations under the two-wheel drive mode.

Thus, according to the present invention, the control amount of the driving force calculated to suppress the sprung vibrations will not disturb the driving force control to achieve the required driving force under the four-wheel drive mode. Consequently, the required driving forces of the front wheels and the rear wheels can be achieved appropriately without being reduced or increased excessively. For this reason, the running performance and the driving characteristics of the vehicle can be improved. Specifically, the four-wheel drive mode is selected to stabilize the vehicle behavior when e.g., a tire slippage occurs. That is, the sprung vibrations is a condition to shift the operating mode to the four-wheel drive mode and hence the sprung vibrations will not be sensed by the driver even if the sprung vibration suppressing control is inhibited. For this reason, running discomfort is reduced so that ride quality of the vehicle can be improved.

### BRIEF DESCRIPTION OF THE DRAWINGS

FIG. 1 is a block diagram showing a configuration of the vibration damping control system according to the present invention.

FIG. 2 is a flowchart showing one example of the control carried out by the vibration damping control system according to the present invention.

FIG. 3 is a flowchart showing another example of the control carried out by the vibration damping control system according to the present invention.

FIG. 4 is a schematic illustration showing a vehicle to which the vibration damping control system according to the present invention is applied.

### DETAILED DESCRIPTION OF THE PREFERRED EMBODIMENT(S)

The present invention relates to a system for suppressing vibrations of a vehicle such as pitching and bouncing, and especially to a system for controlling driving forces delivered to front wheels and rear wheels in such a manner to suppress sprung vibration. Accordingly, the present invention is applied to a vehicle that can be propelled under four-wheel drive mode in which driving force is provided to all four wheels. In the vehicle of this kind, the deriving force delivered to the front wheels and the driving force delivered to the rear wheels can be controlled separately. For example, the present invention may be applied to a four-wheel vehicle in which the driving force generated by an engine can be distributed to the front wheels and the rear wheels while adjusting a distribution ratio of the driving force to the front wheels and to the rear wheels, a hybrid vehicle in which any of the front wheels and the rear wheels are powered by the driving force generated by the engine whereas the other wheels are powered by an electric power generated by the power of the engine, an in-wheel motor vehicle in which all four wheels are individually provided with a motor and so on.

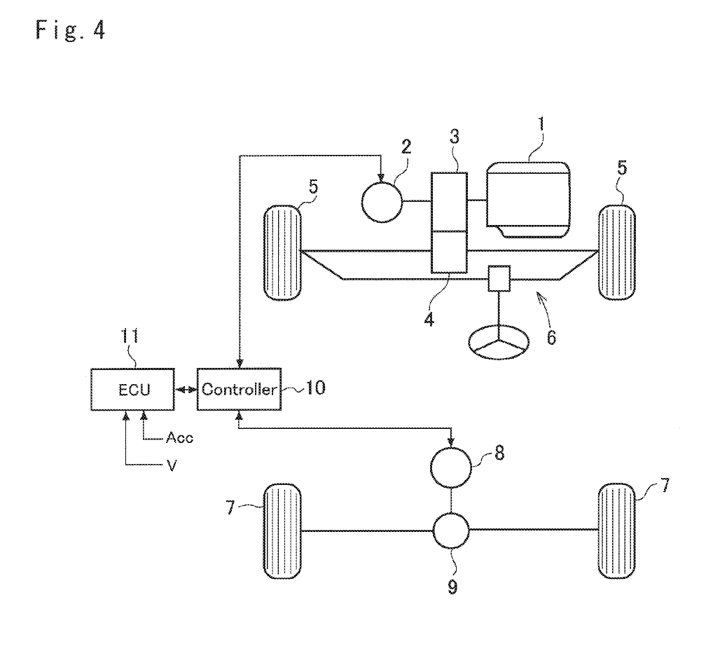

Referring now to FIG. 4, there is schematically shown an example of the hybrid vehicle in which an engine 1 such as a gasoline engine and a motor-generator 2 are connected to a power distribution device 3. In the example shown in FIG. 4, a differential unit such as a planetary gear unit having three rotary elements is used as the power distribution device 3. In the power distribution device 3, specifically, an input element is connected to the engine 1, a reaction element is connected to the motor-generator 2, and an output element is connected to a front differential unit 4. Accordingly, the motor-generator 2 is driven by a power of the engine 1 to generate an electric power, and an output torque of the engine 1 is delivered to the front differential unit 4 by a resultant reaction torque. A pair of front wheels 5 as steering wheels is connected to the front differential unit 4, and the front wheels 5 are turned by a steering mechanism 6. In order to power a pair of rear wheels 7, a second motor-generator 8 is connected the rear wheels 7 through a rear differential unit 9.

Both of the motor-generator 2 of the front wheels 5 and the second motor-generator 8 of the rear wheels 7 are connected to a controller 10 including a battery and an inverter. Here, the motor-generators 2 and 8 may be a motor. The controller 10 is configured to charge the battery when operating any of the motor-generators 2 and 8 as a generator, to operate any of the motor-generators 2 and 8 as a motor by supplying an electric power from the battery, and to select the motor-generators to be used as the motor or the generator from the motor-generators 2 and 8.

The vehicle to which the present invention is applied is further provided with an electronic control unit (ECU) 11. For example, the ECU 11 is configured to shift an operating mode between the two-wheel drive mode in which the driving force is delivered to any one of the pair of front wheels 5 and rear wheels 7 and the four-wheel drive mode in which the driving force is delivered to all of the wheels, to adjust a distribution ratio of the driving force distributed to the front wheels 5 and to the rear wheels 7 under the four-wheel drive mode, and to control the driving force and the braking force applied to the front wheels 5 and to the rear wheels 7 to suppress sprung vibration. Specifically, the ECU 11 is composed mainly of a microcomputer configured to carry out a calculation based on incident data and preinstalled data, and to send a calculation result e.g., to the controller 10 in the form of command signal. For example, an opening degree Acc of an accelerator, rotational speeds of the wheels 5 and 7, a vehicle speed V based on the rotational speeds of the wheels 5 and 7 and so on are sent to the ECU 11.

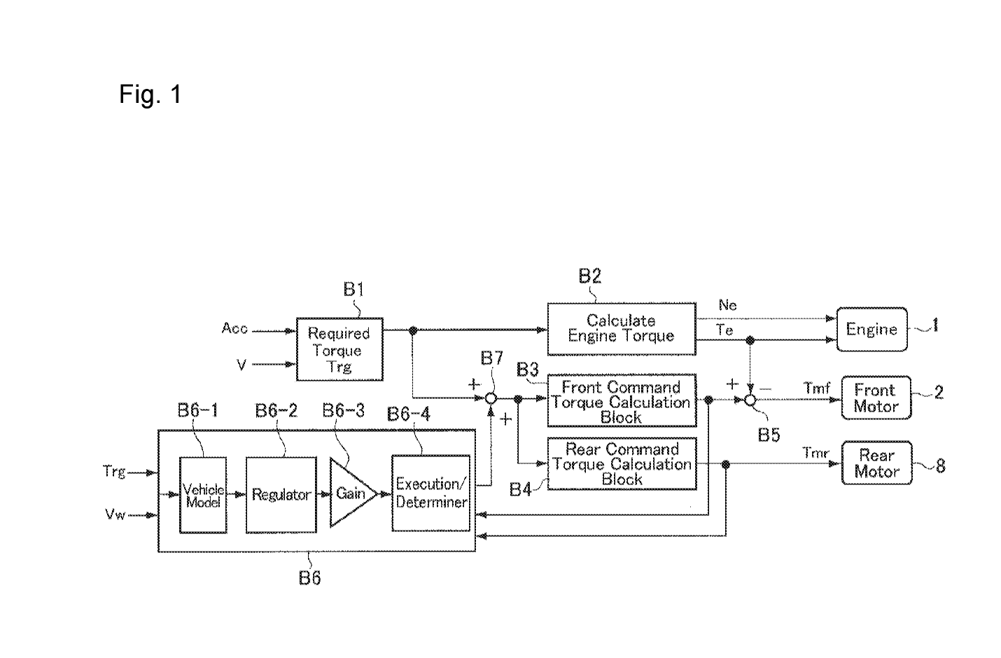

Next, the driving force control of the vehicle thus structured executed by the vibration damping control system according to the preferred example will be explained hereinafter with reference to the block diagram shown in FIG. 1. In order to calculate drive torques of the front wheels 5 and the rear wheels 7 based on a required driving force, first of all, a required torque Trg is obtained based on the opening degree Acc of the accelerator and the vehicle speed V (by a block B1). The running performance and the driving characteristics of the vehicle are governed by the torque generated in accordance with the opening degree of the accelerator. Therefore, the required torque may be determined depending on a type of the vehicle. Specifically, the required torque is obtained by the block B1 with reference to a map determining the required torque based on the opening degree Acc of the accelerator and the vehicle speed V.

Then, an engine torque to achieve the required torque is calculated by a calculating block B2. Specifically, since a required power can be calculated based on the vehicle speed V and the required torque Trq, and the required power thus calculated is to be generated by the engine 1 as a prime mover, a rotational speed Ne and an engine torque Te can be determined at an operating point at which the engine 1 is allowed to generate the required power in an optimally fuel efficient manner. To this end, an optimum fuel economy curve of the engine 1 prepared in advance is used by the block B2, and the target rotational speed Ne and the target engine torque Te can be determined based on the operating point at an intersection between a constant output curve of the target engine power and the optimum fuel economy curve. Then, the engine 1 is controlled in such a manner to generate the target engine torque Te while rotated at the target rotational speed Ne by controlling the engine speed by the first motor-generator 2 or by controlling the torque by adjusting an opening degree of a throttle valve.

Specifically, the required torque Trq is a total torque required to propel the vehicle. Accordingly, the driving force (or driving torque) delivered to the front wheels 5 is calculated by a front command torque calculation block B3, and the driving force (or driving torque) delivered to the rear wheels 7 is calculated by a rear command torque calculating block B4. As described, in the vehicle to which the control system is applied, the operating mode can be switched between the two-wheel drive mode and the four-wheel drive mode, and the power distribution ratio to the front wheels and to the rear wheels can be altered under the four-wheel drive mode. A shifting operation of the operating mode and a selection of the operating mode is executed based on a running condition of the vehicle. For example, the two-wheel drive mode in which the driving force is delivered only to the front wheels 5 is selected when the vehicle is coasting at the constant speed V while keeping the opening degree Acc of the accelerator narrower than a predetermined degree. By contrast, the four-wheel drive mode in which the driving force is delivered to all of the wheels is selected when the opening degree Acc of the accelerator is increased to increase the driving force or when a slippage occurs on any one of the wheels. In this case, the distribution ratio of the driving force to the front wheels and to the rear wheels may be controlled depending on a running condition. That is, the front command torque and the rear command torque are calculated taking account of: a result of the selection of the operating mode such as the two-wheel and the drive four-wheel drive mode based on the opening degree Acc of the accelerator or a tire slippage for calculating the wheels speeds; and the distribution ratio of the driving force to the front wheels and to the rear wheels. Then, a required torque Tmf of the front motor (i.e., the motor-generator 2 of the front wheels 5), and a required torque Tmr of the rear motor (i.e., the motor-generator 8 of the rear wheels 7) thus calculated are transmitted in the form of command signals. Here, since the output torque of the engine 1 is partially delivered to the front wheels 5, the required torque Tmf of the front motor is calculated by subtracting the engine torque Te from the torque command value calculated at the front command torque calculation block by a subtractor block B5.

According to the preferred example, the vibration damping control system is configured to suppress sprung vibrations of the vehicle by controlling the driving force and the braking force applied to the front wheels 5 and the rear wheels 7. In FIG. 1, a sprung vibration controller block is represented by the reference numeral “B6”. As the control described in Japanese Patent Laid-Open No. 2010-285144, according to the preferred example, a vehicle model is used at block B6-1 in the sprung vibration suppressing control. Specifically, the vehicle model B6-1 is an equation of motion of the vehicle using an elastic coefficient of a powertrain, an inertial mass (or an inertial moment), and a damping factor. The aforementioned required torque Trq and a wheel speed (i.e., a rotational number) Vw are substituted into the vehicle model to obtain a coefficient to suppress vibrations by a regulator block B6-2. The aforementioned torque values calculated by the front command torque calculation block B3 and the rear command torque calculating block B4 are inputted to the sprung vibration controller B6, and the sprung vibration controller B6 calculates a control value (i.e., a control torque) for suppressing the sprung vibrations based on a difference between the torque value and a torque value calculated based on the required torque Trq and the wheel speed Vw, and a predetermined gain B6-3.

The sprung vibration controller B6 further comprises a determiner B6-4 for determining an inhibition and an execution of the sprung vibration suppressing control. To this end, the determiner B6-4 is configured to determine an inhibition or a restriction of the sprung vibration suppressing control upon satisfaction of a predetermined inhibiting condition or an restricting condition. Specifically, an establishment of the four-wheel drive mode is used as the inhibiting condition and the restricting condition. For example, given that the establishment of the four-wheel drive mode is used as the inhibiting condition, the control value calculated by the sprung vibration controller B6 will not be transmitted therefrom when the vehicle is propelled under the four-wheel drive mode. By contrast, given that the establishment of the four-wheel drive mode is used as the inhibiting condition, the control value calculated by the sprung vibration controller B6 will be reduced to be transmitted when the vehicle is propelled under the four-wheel drive mode. Specifically, the control value can be restricted by reducing the aforementioned gain B6-3, and to this end, the gain B6-3 is reduced to be smaller value in accordance with the command value transmitted from the sprung vibration controller B6 provided that the distribution ratio of the driving force to the front wheels 5 and the rear wheels 7 is close to “50:50”. By contrast, the condition to execute the sprung vibration suppressing control is satisfied if the vehicle is propelled under the two-wheel drive mode, and in this case, the control amount calculated by the sprung vibration controller B6 is transmitted without being processed.

According to the example shown in FIG. 1, the control amount for suppressing the sprung vibration thus calculated is added to the total torque value calculated by the block B1 by an adder B7. Specifically, in order to simplify the control, the control amount for suppressing the sprung vibration thus calculated is added to the total torque before divided into the required torque Tmf of the front wheel 5 by the front command torque calculation block B3 and to the required torque Tmr of the rear wheels 7 by the rear command torque calculating block B4.

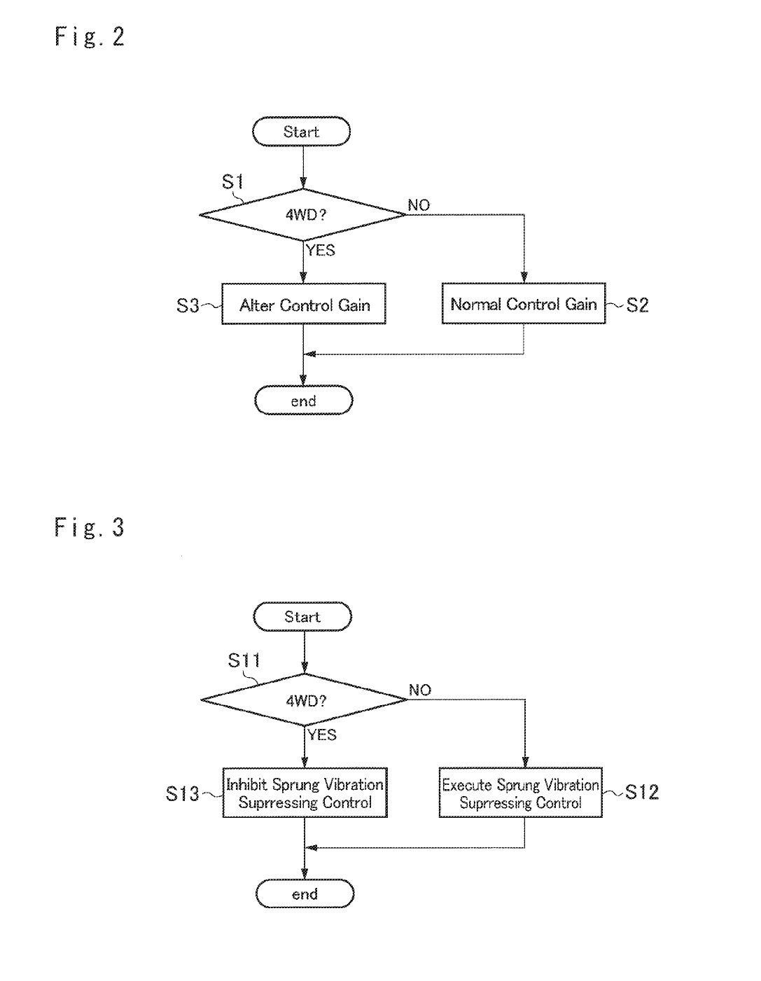

Turning now to FIG. 2, there is shown a flowchart of the control example to restrict the sprung vibration suppressing control when the vehicle is propelled under the four-wheel drive mode. The routine shown therein is repeated at predetermined short period of time. First of all, it is determined whether or not the vehicle is propelled under the four-wheel drive mode (at step S1). As described, the operating mode is selected from the two-wheel drive mode and the four-wheel drive mode based on the opening degree Acc of the accelerator and the wheel speed. At step S1, therefore, the determination of establishment of the four-wheel drive mode can be made based on those factors. If the vehicle is propelled under the two-wheel drive mode so that the answer of step S1 is NO, the normal control gain prepared for the two-wheel drive mode is employed (at step S2).

By contrast, if the vehicle is propelled under the four-wheel drive mode so that the answer of step S1 is YES, the control gain for calculating the control amount to suppress the sprung vibration is altered (at step S3). In this case, the control gain is altered to avoid deterioration in the running performance or the power characteristics of the vehicle due to significant change in the driving force calculated based on the required driving force by the sprung vibration suppressing control. To this end, the control gain is altered in such a manner that the control amount of the driving force to suppress the sprung vibrations is reduced. A degree of such alteration may be determined in advance based on a result of experimentation or simulation.

Turning now to FIG. 3, there is shown a flowchart of the control example to inhibit the sprung vibration suppressing control when the vehicle is propelled under the four-wheel drive mode. First of all, as the aforementioned step S1, it is determined whether or not the vehicle is propelled under the four-wheel drive mode (at step S11). If the vehicle is propelled under the two-wheel drive mode so that the answer of step S11 is NO, the sprung vibration suppressing control is carried out by the normal procedures (at step S12). By contrast, if the vehicle is propelled under the four-wheel drive mode so that the answer of step S11 is YES, the sprung vibration suppressing control is inhibited (at step S13). In this case, the driving force calculated based on the required driving force will not be changed so that the driving force is distributed to the front wheels 5 and to the rear wheels 7 to achieve the required acceleration and the required running stability.

According to the examples shown in FIGS. 2 and 3, therefore, the sprung vibration suppressing control is carried out as designed under the two-wheel drive mode so that running stability and ride quality of the vehicle can be improved. By contrast, when the operating mode is shifted to the four-wheel drive mode to establish greater acceleration and to stabilize vehicle behavior, the sprung vibration suppressing control by altering the driving forces distributed to the front wheels 5 and the rear wheels 7 is inhibited. In this case, therefore, the running performance and the power characteristics of the vehicle can be improved. Specifically, the control amount (of the torque) to suppress the sprung vibrations is added to the total torque, and then the required torques of the front wheels 5 and the rear wheels 7 are calculated based on the torque distribution ratio. Under the four-wheel drive mode, however, the control amount to suppress the sprung vibrations is reduced to be a smaller value or inhibited to be added to the total torque. Therefore, the running stability of the vehicle can be improved under the four-wheel drive mode. Given that the control amount of the torque to suppress the sprung vibrations is thus added to the total torque and then the required torques of the front wheels 5 and the rear wheels 7 are calculated based on the torque distribution ratio, the torque to suppress the sprung vibrations is distributed to the front wheels 5 and the rear wheels 7 based on the distribution ratio. Consequently, the driving forces distributed to the front wheels 5 and the rear wheels 7 may not be controlled appropriately in such a manner to stabilize the vehicle behavior under the condition that the driving force is required, due to difference in timings of generation of the driving forces by the front wheels 5 and the rear wheels 7 and so on. According to the control system of the present invention, however, the control amount to suppress the sprung vibrations is reduced or the sprung vibration suppressing control itself is inhibited under the four-wheel drive mode. According to the present invention, therefore, disturbance in the driving torques of the front wheels 5 and the rear wheels 7 can be reduced to stabilize the vehicle behavior under the four-wheel drive mode.

### REFERENCE SIGNS LIST

1: engine; 2: motor-generator; 3: power distribution device; 4: front differential; 5: front wheel; 6: steering mechanism; 7: rear wheel; 8: motor-generator; 9: rear differential; 10: controller; 11 electronic control unit (ECU).

1: A vibration damping control system for a vehicle, which is configured to suppress sprung vibrations of the vehicle in which a driving force and a braking force applied to front wheels and a driving force and a braking force applied to rear wheels can be controlled separately based on a plurality of data including a required driving force representing a running condition, by controlling at least any one of the driving forces or the braking forces applied to the front wheels and the rear wheels,
wherein the vibration damping control system is configured to restrict the control of the driving forces or the braking forces applied to the front wheels and the rear wheels to suppress the sprung vibrations during propelling the vehicle under four-wheel drive mode in which the driving forces delivered to the front wheels and to the rear wheels are controlled based on the plurality of data including the required driving force representing the running condition.

2: The vibration damping control system for a vehicle as claimed in claim 1, wherein the restriction includes:
a restriction of a control amount of the driving force or the braking force calculated to reduce the sprung vibrations under the four-wheel drive mode to be smaller than that calculated to reduce the sprung vibrations under two-wheel drive mode in which the driving force is distributed only to any one of the pair of front wheels and the rear wheels.

3: The vibration damping control system for a vehicle as claimed in claim 1, wherein the restriction includes:
an inhibition of the control of the driving force or the braking force based on a control amount calculated to reduce the sprung vibrations under the four-wheel drive mode.

4: The vibration damping control system for a vehicle as claimed in claim 2, wherein the vibration damping control system is further configured:
to calculate the driving force to suppress the sprung vibrations using a vehicle model including an equation of motion of the vehicle using an elastic coefficient of a powertrain, an inertial mass, and a damping factor;
to calculate a total driving force by adding said driving force to a driving force calculated based on the required driving force; and
to calculate the driving forces distributed to the front wheels and to the rear wheels.

5: The vibration damping control system for a vehicle as claimed in claim 4, wherein the restriction includes a reduction of a gain used to calculate the driving force to suppress the sprung vibrations under the four-wheel drive mode to be smaller than that used to calculate the driving force to suppress the sprung vibrations under the two-wheel drive mode.
